(19) United States
(12) Patent Application Publication
(10) Pub. No.: US 2026/0326344 A1
(43) Pub. Date: Oct. 22, 2026

(54) APPARATUS FOR SEPARATING PACKAGING MATERIAL FROM PACKAGED ORGANIC MATERIAL

(71) Applicant: ECO-HABITAT B.V., Heiloo (NL)

(72) Inventors: Eduard Johannes Christoffel WIELINGA, Heiloo (NL); Servan KREHER, Heiloo (NL)

(73) Assignee: ECO-HABITAT B.V., Heiloo (NL)

(21) Appl. No.: 19/468,382

(22) Filed: Feb. 3, 2026

(30) Foreign Application Priority Data
Feb. 6, 2025 (NL) 2039738

(51) Int. Cl. B29B 17/02; B29L 31/00

(52) U.S. Cl. CPC B29B 17/02; B29B 2017/0241; B29K 2023/06; B29L 2031/7128; B29L 2031/717

(57) ABSTRACT

The invention is directed to an apparatus for separating metal, plastic and/or paper packaging material from organic material contained by the packaging material. The apparatus comprises an open ended and a horizontally extending tubular part, wherein the tubular part has an inlet opening at one end to receive the organic material contained in packaging material and an outlet opening for separated packaging material at the other end, and a rotating axle shaft positioned co-axial with the tubular part. Along the length of the axle shaft at least two types of vanes alternate and protrude radially from the axle shaft, wherein a first type of vane is connected to the axle under an angle and wherein the second type of vane is connected to the axle substantially co-axial.

### CROSS-REFERENCE TO RELATED APPLICATION

This application claims priority to Dutch Patent Application Serial No. 2039738 filed Feb. 6, 2025 which is incorporated herein by reference.

### FIELD OF THE INVENTION

The invention is directed to an apparatus for separating metal, plastic and/or paper packaging material from organic material contained by the packaging material. The apparatus comprises an open ended and a horizontally extending tubular part. At the lower side of the tubular part openings are present for separating organic material. The tubular part has an inlet opening at one end to receive the organic material contained in packaging material and an outlet opening for separated packaging material at the other end. The tubular part is provided with a rotating axle shaft positioned co-axial with the tubular part. Along the length of the axle shaft separate vanes protrude radially from the axle.

### BACKGROUND

Such an apparatus is described in CN209849030U. This utility model describes an apparatus suited for separating a packaging bag from a packaged food product in a tubular apparatus having a co-axial rotating main shaft. To this shaft knifes and a fan blade are both installed. The fan blades are present to create an air flow and the shaft knives are present to cut open the bags. The food product is separated from the tube via openings at its lower end. The bags leave the tube axially in a gas stream created by the fan blades.

GB2106774 describes an apparatus to separate plastic bags from unsold packaged bread. In this apparatus two parallel screw conveyors which moves the foodstuffs from one end of the apparatus to the next and back. The reduced in size bread is separated via openings in the wall below the screw conveyors. The plastic bags are removed by an air flow through a pipe positioned perpendicular to the screw conveyors.

EP1123868 describes an apparatus for separating bags from their content. The apparatus has a conveyor screw positioned in a channel. The screw opens the bags and is made of a ribbon-shaped metal sheet which is spiral wound. On the internal wall of the channel cutting blades are present having the task to cut the bags.

### SUMMARY OF THE INVENTION

There is currently an interest to process past due date wet and dry groceries from stores and households, for example to a livestock feed component or to an organic fertiliser. This may require the separation of the vegetable and garden waste from its metal and fossil-based plastic packaging material. The prior art apparatuses are capable of separating packaging from packaged organic material. A problem with the prior art apparatuses is that still part of the packaging material itself is separated with the organic material. For example applicant is especially interested to reuse unsold bread as packaged in plastic bags to make livestock feed with an aerobic bacterial process as described in Example 1 of applicants EP4215511. To be able to use the thus obtained digested material as a livestock feed component or as an organic fertiliser it is important that the amount of the packaging material which remains in the organic material after the separation is as low as possible. Prior art processes, especially processes using an apparatus with a screw, are found to break down the packaging material too much and to a too small grain and grit, resulting in that a high content of small packaging material ends up in the separated organic material as a contamination.

The object of this invention is therefore to provide an apparatus which can separate metal, plastic and/or paper packaging material from organic material contained by the packaging material to obtain an organic material containing no or very low contents of the packaging material.

This is achieved by the following apparatus. Apparatus for separating metal, plastic and/or paper packaging material from organic material contained by the packaging material which apparatus comprises
an open ended and a horizontally extending tubular part,
wherein the tubular part has a lower longitudinal side and wherein in the lower side openings for separating organic material are present
wherein the tubular part has an inlet opening at one end to receive the organic material contained in packaging material and an outlet opening for separated packaging material at the other end,
wherein the alternating first type of vane and the second type of vane are positioned in a co-axial row along the axle shaft (6), and
a rotating axle shaft positioned co-axial with the tubular part and wherein along the length of the axle shaft separate vanes protrude radially from the axle, wherein
at least two types of vanes protrude radially from the axle shaft, wherein a first type of vane is connected to the axle under an angle and wherein the second type of vane is connected to the axle substantially co-axial,
wherein the first type of vane alternate with the second type vane along the axle shaft and
wherein the outlet opening is fluidly connected to a means to create a flow of air through the open ended and substantially horizontal tubular part in a direction from the inlet opening towards the outlet opening.

Applicants found that with this apparatus the metal, plastic and/or paper packaging material can be separated from the organic material contained by the packaging material in an efficient manner. Applicants have been able to separate wet and dry grocery goods from its packaging. For example plastic bags have been successfully from packaged bread, metal cans have been successfully separated from the from fluids it contained and fruits and vegetables have been successfully separated from their paper and/or plastic packaging. It is believed that the alternating co-axial and angled vanes achieve this goal. The angled vanes direct the packaged organic material through the opening between the angled vane and the next co-axial positioned vane.

The flow of air thereby assist this passage thereby opening the packaging and releasing the organic material from its packaging. The co-axial positioned vanes subsequently direct the organic material radially outward towards the lower longitudinal side where the organic material is discharged from the tubular part via the openings as present in this lower longitudinal side. The flow of air picks up the packaging material and transports this to the outlet opening. An advantage of this apparatus is that the flow of air can be controlled separately from the rotating speed of the rotating shaft. This allows one to find an optimal combination of rotating speed of the shaft and the speed of the gas flow which may be different for the possible packaged organic materials.

The apparatus has an open ended and a horizontally extending tubular part. By horizontally extending is here meant that the orientation of the axis of the tubular part is horizontal or slightly tilted. Good results are achieved with an horizontal orientation for plastic packaging, like for example polyethylene or polypropylene bags. For metal packaging and heavy plastic and paper packaging the tubular part may suitably be slightly tilted downwards in the processing direction, for example up to 5 degrees from the horizontal.

The length of the tubular part may be between 200 and 400 cm and preferably between 200 and 300 cm. When the tubular part is too short not all of the packaged organic material is unpacked and separated. When the tubular part is too long more of the packaging material has the chance to reduce in size and end up with the separated organic material.

The internal diameter of the tubular part may be between 50 and 100 cm. The tubular part may be made from one tube. Preferably the tubular part is composed of two roll bended parts, wherein one part is the lower longitudinal side having the openings and the other part is an upper longitudinal side. Preferably the angle of the roll bended lower side is smaller than the roll bended upper side. The two roll bended parts may be bolted or welded to each other to obtain the tubular part.

The rotating axle shaft is positioned co-axial with the tubular part. This shaft may have a diameter of between 5 and 15 cm. The diameter is preferably large enough to provide sufficient basis for positioning the vanes.

Along the length of the axle shaft separate vanes protrude radially from the axle. The individual vanes are preferably welded to the shaft. The vanes suitably have a flat surface.

Along the length of the axle at least two types of vanes protrude radially from the axle shaft. Preferably two types of vanes protrude radially from the axle shaft. The first type of vane is connected to the axle under an angle. This angle may be between 10 and 35 degrees with the axis of the axle shaft and preferably between 20 and 30 degrees with the axis of the axle shaft.

The second type of vane is connected to the axle substantially co-axial. The alternating first type of vane and the second type of vane are positioned in a co-axial row along the axle shaft. The row is preferably a straight line co-axial along the surface of the shaft wherein the vanes of the second type run along this line and wherein the axial middle point of the vanes of the second type is positioned on this line. Preferably 2 to 4 rows of alternating first type of vane and the second type of vane run along the rotary shaft and wherein the circular arc between the vanes of neighbouring rows is constant. Preferably 2 of such rows and more preferably 3 of such rows of vanes are connected to the rotating shaft. When 2 rows are present it is preferred that along the shaft 2 vanes of the first type of vane alternates with 2 vanes of the second type of vane. The angle of the constant arc between the vanes of the two rows is 180 degrees. When 3 rows are present it is preferred that along the shaft 3 vanes of the first type of vane alternates with 3 vanes of the second type of vane. The angle of the constant arc between the vanes of the three rows is suitably on average 120 degrees.

Preferably from 5 and up to 10 groups of first and second type vanes are present along the rotating shaft.

The axial length of a vane of the first type may be between 10 and 30 cm and preferably between 10 and 20 cm. The length of the vanes of the second type may be as for the first type. The vanes radially protrude from the rotating shaft towards the internal wall of the tubular part. The radial outer end of a vane of both first and second types and the interior wall of the tubular part is suitably between 1 and 4 cm.

Preferably the axial distance between a first type of vane and a neighbouring second type of vane is between 5 and 8 cm.

The openings for separating organic material as present in the lower side are suitably circular openings having a diameter of between 1.5 and 5 cm. The size of the openings are preferably chosen for the resulting size of the organic material, wherein smaller openings are preferred when the organic material obtained in the apparatus is also small and vice versa. The number of openings per length of the tubular part is suitably between 180 and 215 openings per meter length.

The number of openings as present in the lower side of the tubular part will depend on the size of the openings, the available area and the grid. Preferably the openings are present in an area of the lower part having an arc angle of between 80 and 100 degrees. The grid of the openings may be a triangular grid wherein the distance between the openings is minimised such to maintain just enough mechanical integrity.

The means to create a flow of air is preferably a ventilator. The ventilator is preferably a ventilator which can operate at different throughputs. By being able to vary the throughput the optimal air flows can be achieved within the apparatus achieving the best separation. The ventilator may be connected to the outlet opening via a conduit. The outlet opening is preferably located below the rotating shaft. Air enters the apparatus together with the packaged organic material and also via the openings at the lower side of the tubular part.

At the outlet end the rotating shaft will be supported by bearings. At this point the rotating shaft will have a higher temperature. To avoid that packaging material contacts the locally more warmer rotating shaft it is preferred that a frusto conical part is present around the rotating shaft which directs the gas flow to the outlet opening and avoids that the packaging material contacts the locally more warmer rotating shaft. This frusto conical part results also in that the air flow locally accelerates resulting in an even more lower pressure in the apparatus. Outlet opening is suitably provided with a conical part which also increases the local air speed to move the separated packaging material quickly from the apparatus to a downstream conduit. These measures create a low pressure at the end in the tubular part which enhances the axial flow of air in the tubular part and enhances the separation.

The rotating shaft is suitably functionally connected to a drive means which can rotate the rotating axle shaft at varying rotational speeds. These means may be a motor and preferably an electrical motor. The rotational speeds are preferably between 150 and 300 rpm. By being able to vary the rotational speed the optimal process conditions may be found to operate the apparatus.

The apparatus is provided with an inlet opening to receive the organic material contained in packaging material. Preferably upstream the inlet opening a means is present which can in use supply the organic material contained by the packaging material at a controlled rate to the apparatus. Such a means may be a channel in which a rotary vane is present. The rate of supply is controlled by varying the rotational speed of the rotary vane.

The organic material which is separated in the apparatus and discharged via the openings will fall due to gravity downwards. Preferably a moving belt is positioned below the tubular part to receive these separated organic material. To direct the organic material towards the moving belt it is preferred to connect the tubular part to two side walls, preferably made of a flexible material or partly made of a flexible material, which in use direct the separated organic material to the moving belt. These walls also enhance the horizontal air flow in the tubular part.

The apparatus is preferably used in a process to separate a metal, plastic or paper packaging material from organic material contained by the packaging material into a stream rich in metal, plastic or paper packaging material and a stream rich in organic material. The organic material may be solid or liquid organic material. In this invention liquid organic material is understood to also be aqueous solutions comprising dissolved organic compounds, such as soft drinks and soups. Examples of metal packaging and organic material contained in the metal packaging are packaged fruits and soft drinks. Examples of plastic packaging and organic material contained in the plastic packaging are packaged bread, packaged fruits, like raspberries, packaged vegetables, like beans. Examples of paper packaging and organic material contained in the paper packaging are bread, dry grocery goods as macaroni and rice.

In the above process of this invention the rotating axle shaft preferably rotates at a speed of between 150 and 300 rpm and wherein a forced air flow is created through the tubular part in a horizontal direction from the inlet opening towards the outlet opening. The air gas speed in the tubular part is preferably between 10 and 15 m/s. The relatively low rotational speed avoids the formation of small packaging material fragments.

The process is preferably performed in a mode where the creation of small fragments of packaging material is avoided. This to minimise the content of packaging material which leaves the apparatus via the openings in the lower end and which contaminates the separated organic material. This mode of operation often results in that organic material leaves the apparatus via the outlet opening together with the packaging material. Preferably this flow of packaging material and organic material is enriched in organic material. This enrichment may be performed making use of their difference in density. The thus obtained enriched in organic material stream may advantageously be recycled to the inlet opening of the apparatus. In this manner some of this non-separated organic material will be separated in the apparatus and become part of the separated organic material.

In a preferred process the organic material is bread, such as unsold bread, and the packaging material is a plastic bag, such as a polyethylene or polypropylene bag, or a per bag or a mixture of plastic and paper bags. The bread as obtained is preferably used as a feedstock of an aerobic bacterial process to prepare a digested material. This aerobic process is preferably a process as described in EP4215511 and especially in its Example 1. The digested material is suitable as a livestock feed component, especially for pigs and small pets, like dogs, and which complies with ID number 008912-EN of the Feed Materials Register according to EC Regulation No. 767/2009. The content of plastic and/or paper in the digested material as obtained by this process may even be so low that the digested material may be used to replace part of the flour when making sourdough bread.

### BRIEF DESCRIPTION OF THE DRAWING FIGURES

FIG. 1 shows a side view of an apparatus according to an example embodiment of the invention.

FIG. 2 shows a longitudinal cross-sectional view of the apparatus of FIG. 1.

FIG. 3 shows the apparatus of FIG. 1 from above under an angle and with a cross-sectional view BB’.

FIG. 4 shows cross sectional view BB’ of FIG. 1 in the direction of the outlet (5).

FIG. 5 shows the rotary shaft (6) of the apparatus of FIGS. 1-4.

### DETAILED DESCRIPTION

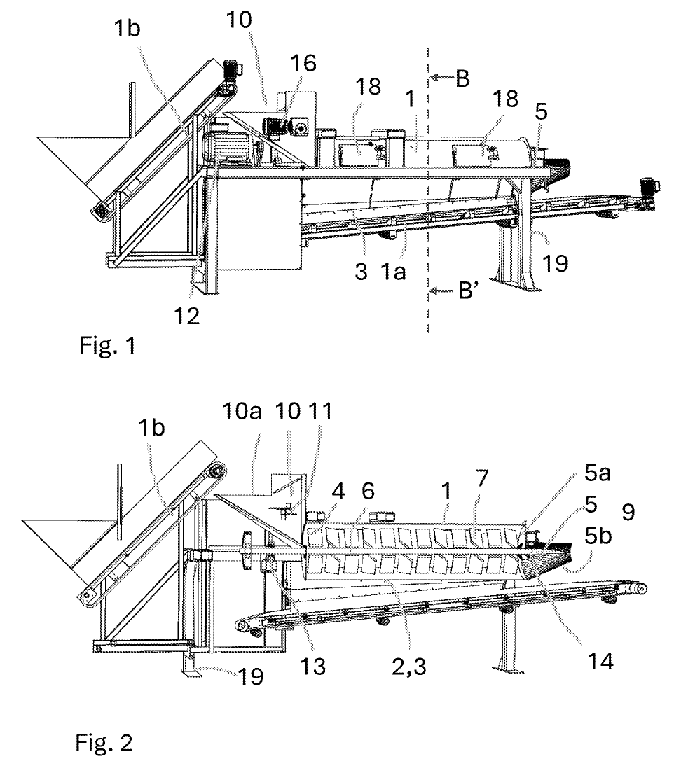

The invention will be illustrated making use of the following FIGS. 1-5.

FIG. 1 shows a side view of the apparatus of this invention having an open ended and a horizontally extending tubular part (1) having an outlet opening (5) supported by a frame (19). Below the tubular part (1) a moving belt (1a) is shown which collects the separated organic material which leaves the tubular part (1) at its lower longitudinal side (2). A supply moving belt (1b) moves the packaged organic material to an inlet (10a) of a channel (10). A motor (12) drives the rotational shaft (6) and a motor (16) is present to drive a rotary vane (11) within channel (10) as shown in FIG. 2. Inspection windows (18) are present in the upper wall section of the tubular part (1).

FIG. 2 is a longitudinal cross-section of the apparatus of FIG. 1. In this view an inlet opening (4) is shown at one end of the tubular part (1) to receive the organic material contained in packaging material and an outlet opening (5) for separated packaging material at the other end. Outlet opening (5) is present in the lower half of the tubular part (1). The upper half of the tubular part (1) is closed by end plate (5a). A rotating axle shaft (6) is positioned co-axial with the tubular part (1) and wherein along the length of the axle shaft (6) separate vanes (7) protrude radially from the axle shaft (6). As shown in more detail in FIG. 4 two types of vanes (7) alternate and protrude radially from the axle shaft (6). The outlet opening (5) may fluidly be connected to a means to create a flow of air through the open ended and substantially horizontal tubular part (1) in a direction from the inlet opening (4) towards the outlet opening (5). Outlet opening (5) is provided with a conical part (5b) which increases the local air speed to move the separated packaging material quickly from the apparatus to a downstream conduit.

A channel (10) is shown for supplying the packaged organic material provided with a rotary vane (11) which can control the supply by varying its rotational speed. An electrical motor (12) drives rotational shaft (6) which shaft (6) is supported by bearings (13, 14).

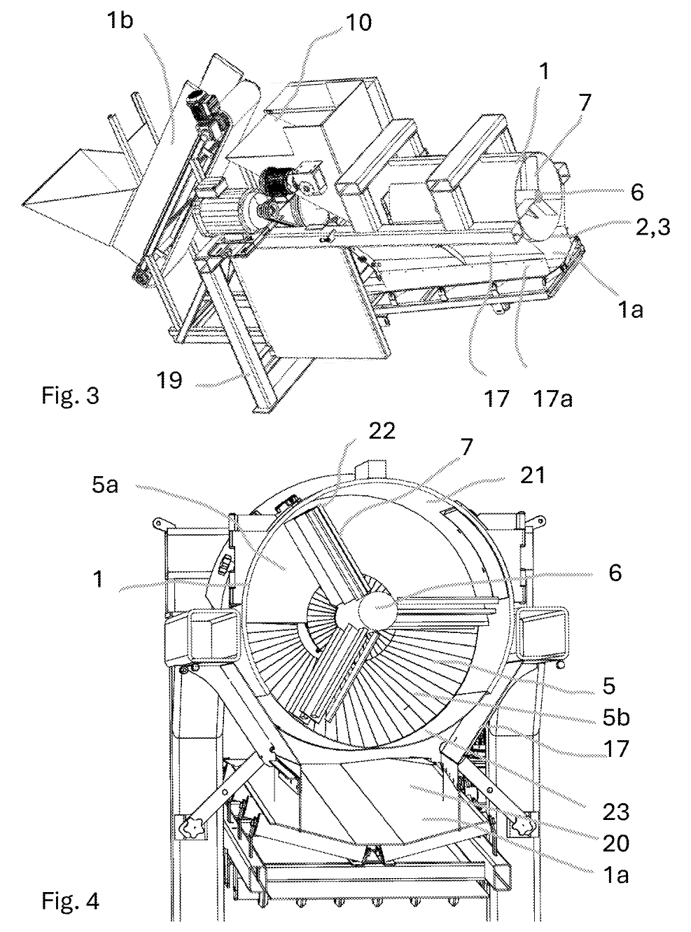

FIG. 3 shows the apparatus from above under an angle and with a cross-sectional view BB’ of FIG. 1. Moving belt (1b), inlet (10a) of channel (10) for supplying packaged organic material is shown. A the lower end of the tubular part (1) wall metal parts (17) and flexible part (17a) are present to direct the separated organic material to the moving belt (1a) and to enhance the axial air flow in the tubular part (1) towards outlet opening (5) which air flow is partly fed by air flowing through the openings (2) in the lower side (3).

FIG. 4 shows a cross sectional view BB’ of FIG. 1 but then in the direction of the outlet (5). The end plate (5a) and outlet opening (5) is shown. The vanes (7) are shown as protruding from the rotary shaft (6). The radial end (22) of the vanes is spaced away from the interior wall (21) of the tubular part (1). The openings (3) are present in an area (23) of the a lower part (1) having an arc angle of about 90 degrees in this figure. This area (23) is enclosed at its lower side by wall parts (17) and an elongated opening (20) running substantially below the area (23). The separated organic material will in used fall down via this opening (20) onto the moving belt (1a).

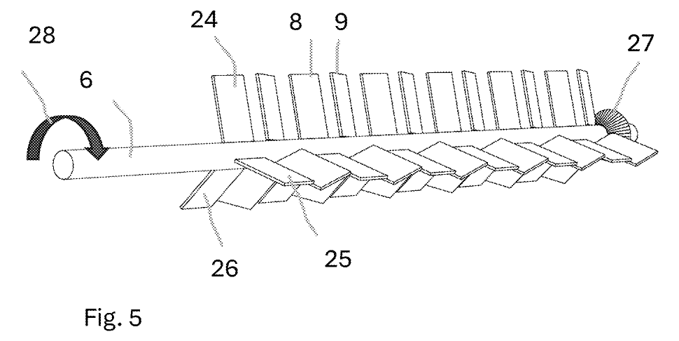

FIG. 5 shows the rotary shaft (6) of the apparatus of FIGS. 1-4. The shaft (6) is shown in the orientation as it would be present in the apparatus of FIG. 1, ie where the inlet opening (4) is at the left hand side and the outlet opening (5) is at the right hand side. Three rows (24,25,26) of alternating the first type (8) and the second type (9) vanes radially extend from the rotary shaft (6). The vanes of the first type make an angle of 25 degrees with the axis and the axial distance between the vanes of the first and second type is 6 cm. This figure also clearly shows that along the shaft 3 vanes of the first type (8) of vane alternates with 3 vanes of the second type (9) of vane. The angle of the constant arc between the vanes of the three rows is suitably on average 120 degrees. A frusto conical part (27) is present around the rotating shaft (6) which directs the gas flow to the outlet opening (5) and avoids that the packaging material contacts the locally more warmer rotating shaft (14). The direction of rotation is shown by arrow (28).

The invention will be illustrated by the following examples

### Example 1

Unsold packaged bread in polyethylene bags were fed to the apparatus of FIGS. 1-5 at a rate of 5.bags per minute. The length of the tubular part was 3 meter. The speed of rotation of the rotary shaft was around 180 .rpm and the air speed in the tubular part was about 13 m/s. 87 wt% of the bread was separated from the packaging material as it was discharged via the openings (2) onto a moving belt. 13 wt% of the bread left the apparatus via outlet opening (5) together with the separated packaging material. The separated bread had a content of polyethylene packaging material of 0.015 wt%.

The separated bread was used as a feedstock of an aerobic bacterial process to prepare a digested material. This aerobic process was a process as described in Example 1 of EP4215511. The digested material was found to be suitable as a livestock feed component, especially for pigs, and which complies with ID number 008912-EN of the Feed Materials Register according to EC Regulation No. 767/2009.

### Example 2

Canned containing soft drinks was fed to the apparatus of FIGS. 1-5 at a rate of 140 cans per minute. The speed of rotation of the rotary shaft was 210 rpm and the air speed in the tubular part was about 18 m/s. 94 wt% of the soft drink was separated from the packaging material as it was discharged via the openings (2) onto the moving belt.

1. An apparatus for separating metal, plastic and/or paper packaging material from organic material contained by the packaging material which apparatus comprises:
an open ended and a horizontally extending tubular part,
wherein the tubular part has a lower longitudinal side and wherein in the lower side openings for separating organic material are present
wherein the tubular part has an inlet opening at one end to receive the organic material contained in packaging material and an outlet opening for separated packaging material at the other end, and
a rotating axle shaft positioned co-axial with the tubular part and wherein along the length of the axle shaft separate vanes protrude radially from the axle shaft,
wherein at least two types of vanes protrude radially from the axle shaft, wherein a first type of vane is connected to the axle under an angle and wherein the second type of vane is connected to the axle substantially co-axial,
wherein the first type of vane alternate with the second type vane along the axle shaft,
wherein the alternating first type of vane and the second type of vane are positioned in a co-axial row along the axle shaft, and
wherein the outlet opening is fluidly connected to a means to create a flow of air through the open ended and substantially horizontal tubular part in a direction from the inlet opening towards the outlet opening.

2. An apparatus according to claim 1, wherein the first type of vane is connected to the axle under an angle of between 10 and 35 degrees with the axis of the axle shaft.

3. An apparatus according to claim 2, wherein the first type of vane is connected to the axle under an angle of between 20 and 30 degrees with the axis of the axle shaft.

4. An apparatus according to claim 1, wherein 2 to 4 rows of alternating first type of vane and the second type of vane run along the rotary shaft and wherein the circular arc between the vanes of neighbouring rows is constant.

5. An apparatus according to claim 1, wherein the axial distance between a first type of vane and a neighbouring second type of vane is between 5 and 8 cm.

6. An apparatus according to claim 1, wherein the distance between the radial outer end of a vane and the interior wall of the tubular part is between 1 and 4 cm.

7. An apparatus according to claim 1, wherein the length of the vane is between 10 and 20 cm.

8. An apparatus according to claim 1, wherein the length of the tubular part is between 200 and 400 cm.

9. An apparatus according to claim 8, wherein the length is between 200 and 300 cm.

10. An apparatus according to claim 1, wherein the diameter of the tubular part is between 50 and 100 cm.

11. An apparatus according to claim 1, wherein the openings for separating organic material as present in the lower side are circular openings having a diameter of between 1.5 and 5 cm.

12. An apparatus according to claim 1, wherein the lower side as wherein openings for separating foodstuffs are present is a lower wall part of the tubular part.

13. An apparatus according to claim 11, wherein the number of openings per length of the tubular part is between 180 and 215 openings per meter length.

14. An apparatus according to claim 1, wherein the outlet opening is fluidly connected to a means to create a flow of air through the open ended and substantially horizontal tubular part in a direction from the inlet opening towards the outlet opening.

15. An apparatus according to claim 14, wherein the means to create a flow of air is a ventilator connected by a conical tube to the outlet opening.

16. An apparatus according to claim 1, wherein a frusto conical part is present around the rotating shaft at the outlet which frusto conical part directs a gas flow to the outlet opening and avoids that the packaging material contacts the locally more warmer rotating shaft.

17. An apparatus according to claim 1, wherein the tubular part is positioned horizontally.

18. An apparatus according to claim 1, wherein the rotating axle shaft is functionally connected to a drive means which can rotate the rotating axle shaft at varying rotational speeds.

19. An apparatus according to claim 1, wherein upstream the inlet opening a means is present which can in use supply the foodstuffs contained by the packaging material at a controlled rate.

20. An apparatus according to claim 19, wherein these means are a rotary vane and wherein the rate is controlled by varying the rotational speed of the rotary vane.

21. An apparatus according to claim 1, wherein a moving belt is positioned below the tubular part to receive in use separated organic material which pass through the openings and wherein to the tubular part is connected to two side walls which direct the separated organic material to the moving belt.

22. A process to separate a metal, plastic or paper packaging material from organic material contained by the packaging material into a stream rich in metal, plastic or paper packaging material and a stream rich in organic material in an apparatus according to claim 1.

23. A process according to claim 22, wherein any foodstuffs present in the stream rich in metal, plastic or paper packaging material is isolated to obtain an enriched stream of foodstuffs and containing some packaging material and recycling this enriched stream to the apparatus.

24. A process according to claim 22, wherein the foodstuffs contained by the packaging material is bread contained in a plastic and/or paper packaging material.
